(19) United States
(12) Patent Application Publication
(10) Pub. No.: US 2006/0184885 A1
(43) Pub. Date: Aug. 17, 2006

(54) SCHEDULING PARTS OF MEETINGS USING ELECTRONIC CALENDARS

(75) Inventors: Kent Fillmore Hayes Jr., Chapel Hill, NC (US); Niraj P. Joshi, Cary, NC (US)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 10/906,337

(22) Filed: Feb. 15, 2005

(51) Int. Cl. G06F 9/00

(52) U.S. Cl. 715/753; 715/963

(57) ABSTRACT

Methods and computer program products for scheduling parts of meetings using electronic calendars. A recipient receives an electronic meeting invitation for a first period of time from an originator. The recipient may accept the invitation for a second period of time, where the second period of time is shorter than the first period of time and lies within the first period of time. A meeting notice corresponding to the second period of time is added to the recipient's electronic calendar. The visual appearance of the recipient's and originator's electronic calendar may be altered in correspondence with the first period of time.

### BACKGROUND OF THE INVENTION

The invention relates to the field of electronic calendars.

Electronic calendars, which may be provided as functions of personal computers, laptop computers, desktop workstations, personal digital assistants, server applications, and the like, have become widely used as a convenient way of keeping track of appointments or meetings. Examples of software program products that provide such functions include Lotus® Notes® and Microsoft® Outlook.

With the agreement of the calendar's user, meetings may be scheduled directly from electronic meeting invitations that arrive in the form of email to add meeting notices to the appropriate pages of the calendar. The recipient of an invitation either accepts the invitation, at which point a meeting notice is added to the recipient's calendar, or declines the invitation. Unfortunately, the recipient's decision must be binary—an invitation is either accepted or declined in its entirety.

Sometimes, however, a recipient of an electronic invitation may wish to accept only part of the invitation. For example, an originator may send an invitation to a plurality of recipients, asking them all to attend an omnibus project-review meeting that spans 8:00 AM to 12:00 noon on a specified day. But the various recipients of the invitation may each need to attend only various parts of the meeting. For example, a first recipient may need to attend only from 8:00 to 8:30, a second from 8:30 to 9:00, and so forth. If any recipient accepts the originator's invitation, however, the calendar of that recipient is blocked for the entire duration of the meeting, rather than only for the time the recipient actually needs to attend the meeting.

Thus, there is a need for a convenient way to enable users of electronic calendars to accept and keep track of parts of meetings that are called using electronic invitations.

### SUMMARY OF THE INVENTION

The invention includes methods and computer program products for scheduling parts of meetings using electronic calendars. A recipient receives an electronic meeting invitation for a first period of time. The recipient may accept the invitation for a second period of time, where the second period of time is shorter than the first period of time and lies within the first period of time. A meeting notice corresponding to the second period of time is added to the recipient's electronic calendar. The visual appearance of the recipient's electronic calendar may be altered in correspondence with the first period of time.

### BRIEF DESCRIPTION OF THE DRAWINGS

FIG. 1 is a flowchart that shows a method for scheduling parts of meetings using electronic calendars.

### DETAILED DESCRIPTION

The present invention will now be described more fully hereinafter, with reference to the accompanying drawing, in an which illustrative embodiment of the invention is shown.

The invention may, however, be embodied in many different forms, and should not be construed as limited to the embodiment set forth herein; rather, this embodiment is provided so that the disclosure will be thorough and complete, and will fully convey the scope of the invention to those skilled in the art.

As will be appreciated by one of skill in the art, the present invention may be embodied as a method, data processing system, or computer program product. Accordingly, the present invention may take the form of an embodiment entirely in hardware, entirely in software, or in a combination of aspects in hardware and software referred to as circuits and modules.

Furthermore, the present invention may take the form of a computer program product on a computer-usable storage medium having computer-usable program code embodied in the medium. Any suitable computer-readable medium may be utilized, including hard disks, CD-ROMs, optical storage devices, magnetic storage devices, and transmission media such as those supporting the Internet or an intranet.

Computer program code for carrying out operations of the present invention may be written in an object oriented programming language such as Java, Smalltalk, or C++. However, the computer program code for carrying out operations of the present invention may also be written in conventional procedural programming languages, such as the C programming language. The program code may execute entirely on the user's computer, partly on the user's computer, as a stand-alone software package, partly on the user's computer and partly on a remote computer, or entirely on a remote computer. The remote computer may be connected to the user's computer through a local area network or a wide area network, or the connection may be made to an external computer, for example through the Internet using an Internet Service Provider.

The present invention is described below with reference to a flowchart illustration and computer program products according to embodiments of the invention. It will be understood that each block of the flowchart can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the specified functions.

These computer program instructions may also be stored, embedded, or embodied in a computer-readable memory that can direct a computer or other programmable data processing apparatus to function in a particular manner, such that the instructions stored in the computer readable memory produce an article of manufacture including instruction means which implement the specified functions.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions and/or acts specified in the flowchart.

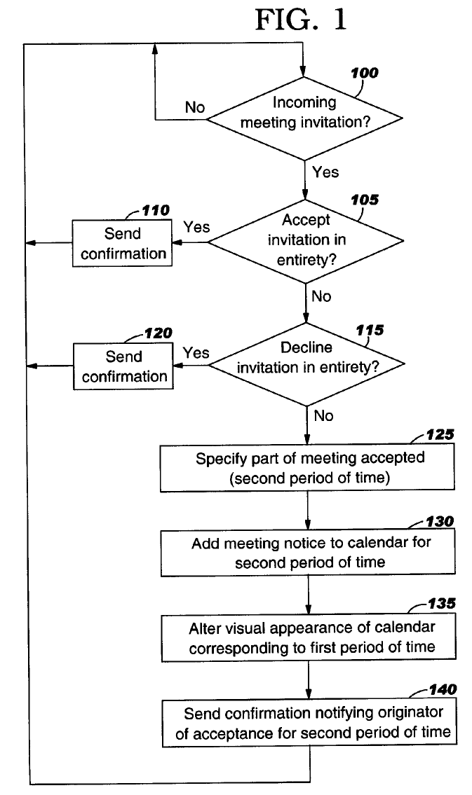

FIG. 1 is a flowchart that shows a method for scheduling parts of meetings using electronic calendars. A recipient's electronic calendar awaits the arrival of an electronic meeting invitation from an originator (step 100). When an invitation arrives, for example when a user opens an invitation sent by email, a determination is made as to whether the user chooses to accept the meeting conveyed by the invitation in its entirety (step 105). The entirety of the meeting is called here the first period of time. For example, the first period of time for a meeting scheduled from 8:00 AM until 12:00 noon on a particular day is 8:00 AM until 12:00 noon of that day. The determination may be made, for example, in response to prompting the user.

If the user accepts the invitation in its entirety, a confirmation is sent to the originator indicating that the meeting is accepted in its entirety (step 110), and the method returns to await the arrival of another meeting invitation (step 100).

Otherwise (i.e., the invitation is not accepted in its entirety), a determination is made as to whether the user declines the invitation in its entirety (step 115). This determination may be made, for example, in response to prompting the user. If the user declines the invitation in its entirety, a confirmation is sent to the originator indicating that the meeting is declined in its entirety (step 120), and the method executed by the recipient returns to await the arrival of another meeting invitation (step 100).

If the invitation is neither accepted in its entirety nor declined in its entirety, part of the meeting is consequently accepted, and the user is prompted to indicate the part of the meeting that is accepted. The part of the meeting that is accepted is called here the second period of time. The second period of time may be any period of time that is shorter in duration than the first period of time and falls within the first period of time. For example, if the first period of time is 8:00 AM until 12:00 noon of a particular day, the second period of time might be 8:30 AM until 9:00 AM of that day.

The user specifies the part of the meeting that is accepted, and thereby specifies, either explicitly or implicitly, the second period of time (step 125). Explicit specification may occur when, for example, the user enters the second period of time directly; implicit specification may occur when, for example, the user accepts a portion of the meeting in response to a prompt, a menu, or the like.

A meeting notice is then added to the user's electronic calendar for the second period of time (step 130). Thus, in the running example introduced above, the meeting notice for the second period of time would appear on the user's calendar page for the day of the meeting, showing the partial meeting as occurring from 8:30 AM until 9:00 AM of that day.

In some circumstances, it may be useful to the user to keep informed of the original duration of the meeting, i.e., the first period of time. For example, the user might want to attend, time permitting, other parts of the meeting besides the part that occurs during the second period of time. So the visual appearance of the calendar may be altered corresponding to the first period of time (step 135). In the running example, not only is a meeting notice put on the appropriate calendar page in correspondence with the second period of time, i.e., 8:30 AM until 9:00 AM of that day, but the visual appearance of the calendar may be altered in correspondence with the first period of time, i.e., 8:00 AM until 12:00 noon of the same day, which is the full period of time carried by the original meeting invitation.

The visual appearance of the calendar may be altered in any way that conveys the first period of time to the user. For example, a block on the calendar page corresponding to the first period of time may be colored with a light gray or with a pastel, thus allowing other items in the block to be seen through the coloration; a note or footnote may be added to the calendar page informing the user of the first period of time; and so on.

A confirmation may be sent to the originator indicating that the user has accepted part of the meeting for the second period of time (step 140); the process executed by the recipient returns to await the arrival of another electronic meeting invitation (step 100). Responsive to the confirmation just mentioned, the originator may update a second electronic calendar, e.g., one used by the originator, to post a meeting notice that shows the second period of time. Thus, the visual appearance of the originator's electronic calendar may also be altered based on meeting acceptance by the recipient.

The methods and computer program products of the present invention also apply to enable the originator to send an invitation for a meeting for a first period of time, and himself or herself accept and schedule part of the meeting for a second period of time, where the second period of time is shorter than the first period of time.

In addition, the methods and computer program products of the present invention also apply to enable an originator to send an invitation for a meeting that spans a first period of time, and specify within the invitation second periods of time that pertain to a plurality of recipients of the invitation. In the running example of the omnibus project meeting scheduled for 8:00 AM to 12:00 noon, the electronic meeting invitation may invite a first recipient to attend from 8:00 AM to 8:30 AM, a second recipient from 8:30 AM to 9:00 AM, and so forth. Here, the first period of time would be 8:00 AM to 12:00 noon. From the point of view of the first recipient, the second period of time would be 8:00 AM to 8:30 AM, whereas, from the point of view of the second recipient, the second period of time would be 8:30 AM to 9:00 AM. A recipient may decline the meeting, accept the meeting for the first period of time or for their respective second period of time, or accept the meeting for some second period of time that is not the same as the second period of time conveyed by the invitation. Recipients' acceptances may be recorded on the originator's electronic calendar, where deviations from the originator's first intent cause visual alterations of the calendar page to draw the originator's attention.

Although the foregoing has described methods and computer program products for scheduling attendance for parts of meetings using electronic calendars, the description is illustrative of the invention rather than limiting; the invention is limited only by the claims that follow.

What is claimed is:

1. A method for scheduling meetings on electronic calendars, said method comprising:
receiving a meeting invitation for a meeting for a first period of time;
accepting part of the invitation for a second period of time that falls within the first period of time, where the second period of time is shorter than the first period of time; and
including a meeting notice on a first electronic calendar for the second period of time.

2. The method of claim 1, further comprising altering the visual appearance of the first electronic calendar in correspondence with the first period of time.

3. The method of claim 2, wherein altering the visual appearance of the first electronic calendar includes coloring a time slot corresponding to the first period of time on the first electronic calendar.

4. The method of claim 2, wherein altering the visual appearance of the first electronic calendar includes marking a calendar page that includes the meeting notice to indicate the first period of time on the first electronic calendar.

5. The method of claim 1, further comprising sending a confirmation responsive to accepting part of the invitation, said confirmation being for the second period of time.

6. The method of claim 5, further comprising receiving the confirmation and including a meeting notice corresponding to the second period of time, on a second electronic calendar, responsive to the confirmation.

7. A computer program product for scheduling meetings on electronic calendars, the computer program product comprising a computer readable medium having computer readable program code embedded therein, the computer readable program code comprising:
computer readable program code configured to receive a meeting invitation for a meeting for a first period of time;
computer readable program code configured to accept part of the invitation for a second period of time that falls within the first period of time, where the second period of time is shorter than the first period of time; and
computer readable program code configured to include a meeting notice on a first electronic calendar for the second period of time.

8. The computer program product of claim 7, wherein the computer readable program code further comprises computer readable program code configured to alter the visual appearance of the first electronic calendar in correspondence with the first period of time.

9. The computer program product of claim 8, wherein the computer readable program code configured to alter the visual appearance of the first electronic calendar includes computer readable program code configured to color a time slot corresponding to the first period of time on the first electronic calendar.

10. The computer program product of claim 8, wherein the computer readable program code configured to alter the visual appearance of the first electronic calendar includes computer readable program code configured to mark a calendar page that includes the meeting notice to indicate the first period of time on the first electronic calendar.

11. The computer program product of claim 7, wherein the computer readable program code further comprises computer readable program code configured to send a confirmation responsive to accepting part of the invitation, said confirmation being for the second period of time.

12. The computer program product of claim 7, wherein the computer readable program code further comprises computer readable program code configured to receive the confirmation and include a meeting notice corresponding to the second period of time, on a second electronic calendar, responsive to the confirmation.

13. A computer program product for scheduling meetings on electronic calendars, the computer program product comprising a computer readable medium having computer readable program code embedded therein, the computer readable program code comprising:
computer readable program code configured to receive a meeting invitation for a meeting for a first period of time;
computer readable program code configured to accept part of the invitation for a second period of time that falls within the first period of time, where the second period of time is shorter than the first period of time;
computer readable program code configured to include a meeting notice on a first electronic calendar for the second period of time;
computer readable program code configured to alter the visual appearance of the first electronic calendar in correspondence with the first period of time; and
computer readable program code configured to send a confirmation responsive to accepting part of the invitation, said confirmation being for the second period of time.

14. The computer program product of claim 13, wherein the computer readable program code further comprises computer readable program code configured to receive the confirmation and include a meeting notice, corresponding to the second period of time, on a second electronic calendar, responsive to the confirmation.

15. The computer program product of claim 13, wherein the computer readable program code configured to alter the visual appearance of the first electronic calendar includes computer readable program code configured to color a time slot corresponding to the first period of time.

16. The computer program product of claim 13, wherein the computer readable program code configured to alter the visual appearance of the first electronic calendar includes computer readable program code configured to mark a calendar page that includes the meeting notice to indicate the first period of time.
